(19) United States
(12) Patent Application Publication
(10) Pub. No.: US 2018/0312157 A1
(43) Pub. Date: Nov. 1, 2018

(54) GOD DRIVE SYSTEM FOR APPLYING GASOLINE TO A HYBRID VEHICLE FUEL TANK ONCE A YEAR VIA AN ENGINE CONTROL-UNIT (ECU) COMPUTER

(71) Applicant: HERBERT R. FLOYD, New York, NY (US)

(72) Inventor: HERBERT R. FLOYD, New York, NY (US)

(21) Appl. No.: 15/582,498

(22) Filed: Apr. 28, 2017

(51) Int. Cl. B60W 20/13; B60W 10/06; B60W 10/08; B60L 11/18; B60K 6/40; B60K 35/00

(52) U.S. Cl. CPC B60W 20/13; B60W 10/06; B60W 10/08; B60K 6/44; B60K 6/40; B60K 35/00; B60L 11/1814

(57) ABSTRACT

A first, and second twin AC inverters for a hybrid vehicle, whereby, the first and second inverters having a first, and second twin AC hard wire terminal blocks, a cool-down C-D process, and a conventional Engine Control Unit computerized remote-control drive system, whereby, being capable of activating the twin AC terminal blocks for Freeway speed, hills, faster acceleration, and a hybrid vehicle momentum regenerative braking kinetic energy process for: charging a battery-pack, and multiple batteries. The computer being capable of activating the first terminal block, when the cool-down process is to end, and deactivating the second terminal block, when the cool-down process is to began. The Computer is capable of activating the first, or second terminal blocks, whereby, for operating in conjunction with one another for the Freeway speed for charging the battery-pack, including multiple batteries with respect to the above modification.

### CROSS-REFERENCES TO RELATED APPLICATION

This application is a continuation-in-part of application Ser. No. 12/291,058, filed on Jul. 3, 2009, now abandoned, which is a continuation-in-part of Ser. No. 12/799,923, filed on May 3, 2010, now abandoned, which is a continuation-in-part of Ser. No. 13/065,001, filed on Mar. 11, 2011, now abandoned, which is a continuation-in-part of Ser. No. 13/373,422, filed on Nov. 14, 2011 now abandoned, which is a continuation in part of Ser. No. 13/573,701, filed on Oct. 3, 2012 now abandoned.

### BACKGROUND OF THE INVENTION

### 1. Field of the Invention

The present invention appertains generally to hybrid vehicles, and specifically to an electrical system, which is capable of causing a hybrid vehicle's fuel-tank to be filled with gasoline, only once a year. When the vehicle is started, its instrument panel recites: 1^{ST}. GAS-UP: 01/01/2015, 2^{ND}. GAS-UP: 01/01/2016. As the computer is capable of using a severe case of scrutiny via the entire hybrid system, an internal combustion engine is now used, only at start up, since once ounce of gasoline is capable of starting the internal combustion engine, Thus, a hundred and twenty eight ounces of the gasoline is equivalent to a hundred and twenty eight startups per gallon. While the hundred and twenty eight startups per gallon are multiplied by a twenty gallon fuel-tank, the gasoline is capable of yielding 2,560 start-ups per year concerning the life style of a user via modification, and a twin cool-down (C-D) drive system.

### 2. Description of the Prior Art

Since The US is at War with her adversary in the middle-east, The US military consumes about 1,7 million gallons of gasoline a day in Iraq. With respect to the DOD, the present invention is capable of causing tanks, hybrid tactical vehicle, and the Army's fleet of manned ground. vehicles to gas-up once a year. This will save the US billions of Dollars a year, since a hybrid vehicle cool-down process is defined by a 12.000 Watt twin inverter, via twin AC hardwire 12,000 W terminal blocks, and the engine management computer drive system for: activating US tanks concerning long trip technology. The computer is capable of activating the terminal blocks at an end of each cool-down C-D process with respect to the above modification.

### SUMMARY OF THE INVENTION

Accordantly, it is a principle object of the present invention to produce a system for: applying gasoline to a hybrid vehicle fuel tank once a year, whereby, having a first, and second twin inverters, a first, and second twin AC hardwire terminal blocks each of which, is defined by a cool-down process with respect to the above modification concerning the foregoing. Moreover, to accomplish the foregoing, and other objects, the cool-down process is capable of preventing The First Law of Thermodynamics from being, thereby, violated, seeing that a conventional engine management computer, remotely, controls the vehicle drive system. The computer is capable of activating the terminal blocks each of which is for: freeway speed, hills including faster acceleration, for charging the vehicle battery-pack. Seeing that the computer is capable of detecting, when the cool-down process is to end for the first terminal block, the computer is capable of activating the first terminal block upon the detection. The first terminal block is now capable of operating in conjunction, therewith, the second terminal block. The first and second twin inverters each of which is capable of supplying a second electric motor/generator with AC current for: the freeway speed, hills, and faster acceleration, for recharging the battery-pack concerning long trip technology.

According to another object regarding the invention, a system for applying gasoline to a hybrid vehicle fuel tank once a year having a first, and second twin inverters, a first and second twin AC hardwire terminal blocks a cool-down process, and an engine management computerized remote control drive system comprises: A mid-size hybrid vehicle having the first, and second twin inverters, the first and second AC terminal blocks, and eight terminals for: joining to a first, second, third and fourth batteries. A Luxury hybrid vehicle having a third and fourth twin inverters, a third and fourth twin AC hardwire terminal blocks, the cool-down CD process, and the engine management computerized remote control conventional drive system.

A heavy-duty hybrid tactical US military vehicle having a fifth and sixth twin inverters, a fifth, and sixth twin AC hardwire 3 phase 24 vdc three wire system terminal blocks, the cool-down process, and the computer remote control drive system, whereby, capable of operating via US tanks, including the US Army's fleet of manned ground vehicles for: applying fuel to each gas-tank once a year. An instrument panel readout screen, and an ignition key-slot, thus, the key-slot is capable of receiving the ignition key for: activating the readout screen. A first Switch, of a keypad is adjacent to the instrument panel readout screen. The first switch is defined by a finger placement surface being shaped to conform to the contours of the finger for: thereby, activating the readout screen, where upon the activation; the readout screen indicates: 1^{ST}GAS-UP: 01/01/2014, 2^{ND} GAS-UP: 01/01/2015. A second switch of the second twin inverter activated by the computer, a third switch of the first inverter, a fourth, and fifth switch, of the third, and fourth twin inverters, activated by the computer, and a sixth and, seventh switch of the fifth and sixth twin inverters, whereby, activated via the computer. A fifth conventional motor/generator, connected to a conventional power-splitting device for: distributing power produced by an internal combustion engine (ICE) to a drive train's reduction gears. A sixth motor/generator connected to the fifth and sixth twin inverters. The fifth inverter, whereby, joined to a conventional battery-pack for: converting DC supplied by the battery-pack to AC for activating the fifth, and sixth motor/generators, and for converting the AC supplied by the fifth, and sixth motor/generators into DC for recharging the battery-pack. The vehicle having a third charger capable of charging a ninth, tenth, eleventh, and twelfth batteries, whereby, the fourth twin AC hardwire terminal block being fixed on the fourth twin inverter, thereby, connected to the battery-pack for: converting DC supplied by the battery-pack to AC for activating the fourth motor/generator. The fourth motor/generator is connected to a conventional outlet of the fourth inverter via a fourth plug. A second battery charger is connected to the fourth twin inverter. The second charger and the fourth twin inverter is, thereby, connected to a fifth, sixth, seventh, and eight batteries for: activating the second motor/generator. The third motor/generator being connected to the fifth, sixth, seventh, and eight batteries, and when the second battery charger is connected to a conventional outlet of the fourth twin inverter by a fifth plug, the fourth motor/generator is connected to the third inverter via a sixth plug. The second charger being capable of charging the fifth, sixth, seventh, and eight batteries for: supplying energy to the vehicle by its electric motor via the third, and fourth inverters, and by the fourth motor/generator. Consequently, the gasoline engine is capable of starting, via one ounce of such gasoline, one hundred and twenty eight ounces concerning the gasoline is equipollent to one gallon of the gasoline, and capable of yielding a hundred and twenty eight startups per gallon. As a ride, one hundred and twenty eight startups per gallon being multiplied by a twenty-gallon fuel tank, the gasoline yields: 2,560 startups per year. The third twin AC terminal block is defined by 10,000 Watts fixed on the third twin inverter for the cool-down process. The computer is capable of detecting when the cool-down process is to begin, and capable of deactivating the third terminal block, at the threshold to exclude The First Law of Thermodynamics from being violated. Whereby, the fourth twin AC terminal block is being defined by 10,000 Watts, and fixed on the fourth twin inverter. The computer being capable of detecting, when the cool-down process is to begin, and capable of deactivating the fourth terminal block upon the detection, whereby, to prevent from violating The First Law of Thermodynamics. The computer being capable of detecting, when the change in internal energy of the system is equal to the heat added to the system minus the work performed by the system. The computer being capable of excluding the ICE from turning on, when The First Law of Thermodynamics is excluded from being violated via the C-D beginning stage. Whereby, the computer being capable of activating the 10,000 Watt third or fourth twin AC terminal blocks, for: freeway speed, hills, and faster acceleration for charging the battery-pack. The cool-down process is defined by long trip technology. The fourth 10,000 Watt AC terminal block being fixed on the fourth inverter, concerning the cool-down process. The computer is capable of detecting, when the cool-down-process is to end and, capable of activating the fourth terminal block. The third, and fourth twin inverters having a third, fourth, fifth, and sixth, fans about The First Law of Thermodynamics via the application of the conservation of energy principle to heat, and Thermodynamic processes.

The fourth motor/generator is being joined to an outlet of the third inverter by the sixth plug for: performing an activation of the motor, via the fourth motor/generator. The motor is capable of operating via a generator. The third 10,000 Watt terminal block is capable of operating at the end of the cool-down process. The computer is capable of deactivating the fourth 10,000 Watt terminal block, and activating the third terminal block for the freeway, speed. The computer being capable of deactivating the second battery charger, when the fifth, sixth, seventh, and eight batteries are defined by full charge status. The second motor/generator being joined by a second 8,000 Watt inverter, by a first plug, a first charger joined to the second inverter by a second plug, and the second motor/generator joined to the first inverter by a third plug. The third and fourth inverters are fixed on a surface in a trunk. The computer being capable of activating the second 8,000 W terminal block, when the cool-down process is to end. The second terminal block is capable of operating in conjunction with the first terminal block before its cool-down process is to begin. Whereby, the first motor/generator being joined to the first 8,000 Watt inverter having a third, and fourth fans. The first and second twin inverters and the first charger are joined to a first, second, third, and fourth batteries. The first charger is for charging the first, second, third, and fourth batteries. As a rule, the computer being capable of activating the 8,000 Watt first, or second twin AC terminal blocks for the freeway speed, for charging the battery-pack; The second inverter having a first, and second fans, via the C-D process. The twin AC hardwire 3 phase, 24 vdc defined by 12,000 Watt fifth, and sixth terminal blocks, and, concerning the cool-down process. The computer being capable of detecting when the cool-down process is to begin/end for preventing The First Law of Thermodynamics from being violated, regarding the principle of conservation of energy. Whereby, the computer is capable of activating the fifth 12,000 Watt terminal block at the end of the cool-down process. The sixth terminal block thus, being capable of operating together with the fifth terminal block until its cool-down process is to begin.

According to further objects, a system for applying gasoline to a hybrid vehicle fuel tank once a year having a third, and fourth twin inverters, a third and fourth twin AC hardwire terminal blocks, a cool-down process, and an engine Control Unit computer remote control drive system, comprises. A Luxury hybrid vehicle having a third and fourth twin inverters, a third, and fourth twin AC hardwire terminal blocks, the cool-down process, and the engine Control Unit computerized remote control conventional drive system. A third, and fourth conventional motor/generators, thereby, connected to a conventional power splitting device capable of distributing power being produced by an internal combustion engine ICE to a drive train's reduction gears. The hybrid vehicle electric motor being capable of operating in conjunction with the ICE, the hybrid vehicle having a throttle being capable of causing current to switch direction, and being capable of moving the fourth motor/generator from motor mode to generator mode and capable of generating a regenerative braking process. The motor is now defined by a fourth motor/generator. A Power-split or series-Parallel hybrid vehicles being generally defined by the ICE, and the electric motor both of which, having a direct mechanical coupling to the electric drive train. The engine is being defined by the coupling to the third and fourth motor/generators for gear ratios also. The drive train whereby, including a conventional Transmission, being capable of shifting, whereby, to thus, provide the necessary gear ratios for: conventional hybrid operation, whereby, having an electrically, variable transmission (EVT) to provide variable speed ratios. An output shaft of the ICE, and an output shaft of the electric motor both of which are capable of being, thereby, connected in parallel via a coupling device, thereby, being capable of decreasing harmful exhaust emissions, and maximizing fuel economy. The hybrid vehicles being generally defined by the regenerative braking, which is an energy recovery mechanism being capable of slowing the vehicle by converting its kinetic energy into another form, whereby, the energy is capable of being consumed immediately or stored, thereby, being capable of recharging the fifth, sixth, seventh, and eighth batteries of the Luxury hybrid vehicle. The computer, thereby, being capable of detecting, when the fifth, sixth, seventh, and eighth batteries are being charged by the regenerative braking energy. The computer being predetermined and capable of detecting, when the change in internal energy of the hybrid vehicle system is equal to the amount of heat supplied to the system, minus the amount of work performed by the system. The computer is capable of turning on the ICE, when The First Law of Thermodynamics is at the threshold of being violated. The computer being capable of detecting, when the cool-down process is to, thereby, prevent The First Law of Thermodynamics from being violated. The computer being capable of excluding the ICE from turning on, when The First Law of Thermodynamics is excluded from being violated via the C-D process, and via the conservation of energy. The regenerative braking energy is being capable of charging the fifth, sixth, seventh, and eighth batteries including the hybrid vehicle battery-pack. The computer is being capable of detecting, when the cool-down process is to begin/end with respect to The First Law of Thermodynamics concerning long trip technology.

A system for applying gasoline to a hybrid vehicle fuel tank once a year, comprises: a first and second twin AC inverter for: the hybrid vehicle. The first and second inverters having a first and second twin AC hardwire terminal blocks, a cool-down C-D process, and a conventional engine management computerized remote-control drive system, whereby, being capable of activating the twin AC terminal blocks for freeway speed, hills, faster acceleration, and a hybrid vehicle momentum regenerative braking kinetic energy process for: charging a battery-pack, and multiply batteries. The computer being capable of activating the first terminal block, when the cool-down process is to end, and deactivating the second terminal block, when the Cool down process is to begin. The computer is capable of activating the first/second terminal blocks, simultaneously, for operating in conjunction with one another for the freeway speed.

The regenerative braking is an energy recover mechanism, thereby, being capable of slowing the vehicle by converting the kinetic energy into another form, which is capable of being used immediately, or stored in the multiple batteries, and the battery-pack. The regenerative brake must be combined via a friction brake for stopping short. The computer being capable of deactivating the first terminal block, when the first terminal block is being defined by the cool-down process, whereby, to prevent The First Law of Thermodynamics from being, thereby, violated via an amount of heat generated with respect to the application of the conservation of energy. The computer being capable of activating the second terminal block simultaneously, when the cool-down process of the second terminal block is to end. The second inverter being capable of supplying AC current concerning a conventional hybrid electric motor via a motor/generator to propel the vehicle along a surface of a road. The cool-down process with respect to earth includes: winter, spring, summer, and fail, including rain, snow, hail-storms defined by ice, and the greatest cool-down process upon the face of the earth being the Ocean. The ocean being capable of cooling-down the earth to prevent from violating The First Law of Thermodynamic processes. The earth being defined by a change in internal energy of its system, whereby, being capable of performing a manner of work via rotating, thereby, being equal to the heat added to the earth's system via a greater light to rule the day, and minus the work performed by the system. As a rule, the Ocean is capable of preventing The First Law of Thermodynamics from being violated, whereby, the Ocean being defined by a conventional cool-down process with respect to the face of all the earth. I wisdom dwell with prudence, and find out knowledge of witty inventions.

### BRIEF DESCRIPTION OF THE DRAWINGS

Further objects and advantages given herewith about the present invention will become apparent, however, from the drawings with respect to the preferred embodiments concerning the invention, and the description thereof;

FIG. 1 is a block diagram of a hybrid vehicle cool-down process having a first and second twin inverters, whereby, defined via a first and second AC hardwire terminal blocks, and an engine management computer drive system for: activating the twin inverter's terminal blocks for freeway speed, and long trip technology;

FIG. 2 is a front end view of the second 8,000 Watt remote control inverter, whereby, having the hardwire direct terminal block including a switch, and four conventional outlets;

FIG. 3 is a rearward view of the second 8,000 W. inverter, thus having dual cooling fans, including eight terminals for: connecting to a first, second, third, fourth storage batteries, and the hybrid vehicle battery-pack;

FIG. 4 is a rearward view of the vehicle trunk housing a third, and fourth twin 10,000 Watt inverters for activating the hybrid vehicle electric motor;

FIG. 5 is defined by a step-by-step flowchart being described in more detail via FIG. 1;

FIG. 6 is a perspective view of an instrument panel readout-screen which recites: GAS-UP EACH YEAR VIA C-D PROCESS, and further recites: 1^{ST}. GAS-UP: 01/01/2014, 2^{ND} GAS-UP: 01/01/2015, whereby, an ignition key is capable of activating the readout screen;

FIG. 7 is a perspective view of a gasoline engine connected to a conventional carrier, a generator via a second motor/generator, a ring gear, a hybrid electric motor, and out-put shaft;

FIG. 8 is a block diagram of the hybrid vehicle cool-down process, thereby, having a third and fourth 10,000 Watt twin inverters defined by a third and fourth 10,000 Watt AC hardwire terminal blocks, and the Engine Control Unit (E C U) Computer drive system;

FIG. 9 is a block diagram of the hybrid vehicle cool-down process, thereby, having a fifth and sixth twin inverters defined by a fifth, and sixth twin AC hardwire 12,000 Watt terminal blocks, and the E C U engine management computer drive system for: activating US tanks;

FIG. 10 is a side view of a Luxury hybrid limousine having twin AC hardwire 10.000 Watt third, and fourth inverters max/20,000 Watts surge terminal, blocks, whereby activated via the ECU computer drive system for: freeway speed, hills, faster acceleration for Charging the battery-pack, and for: activating the twin terminal blocks for long trip technology;

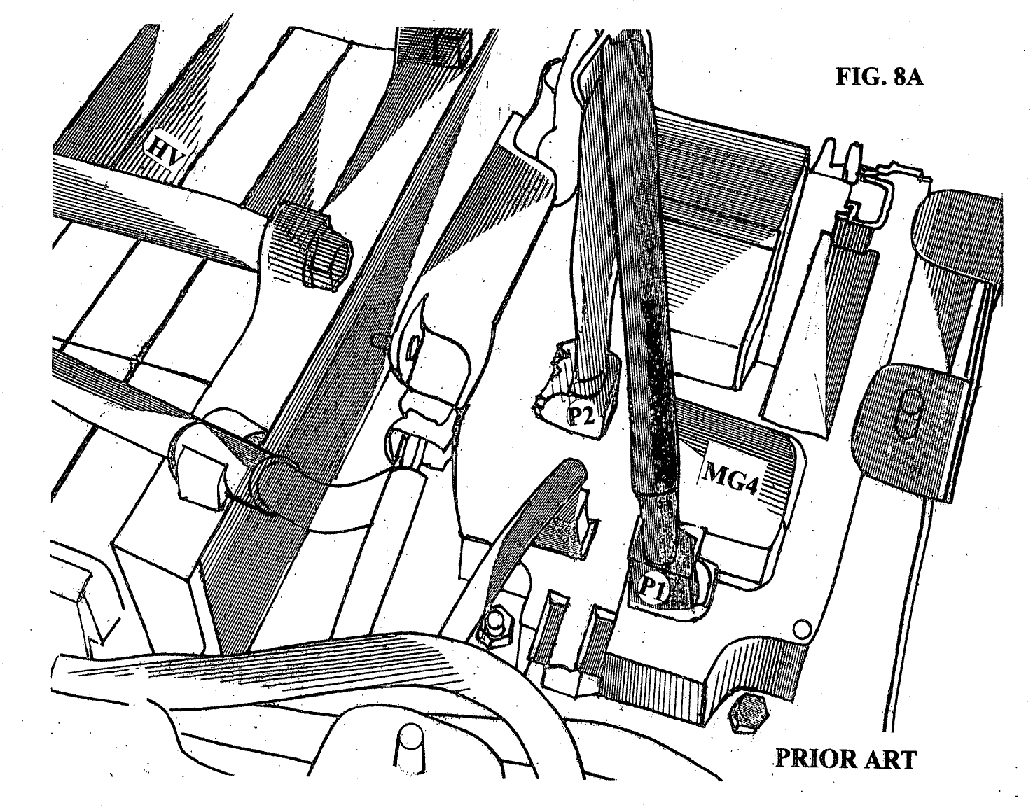

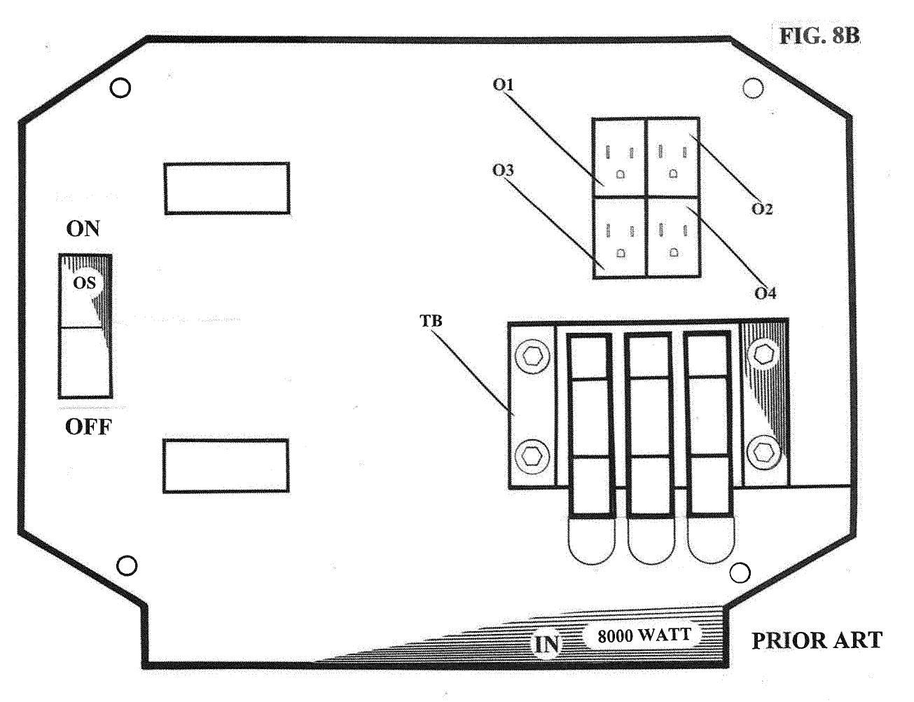

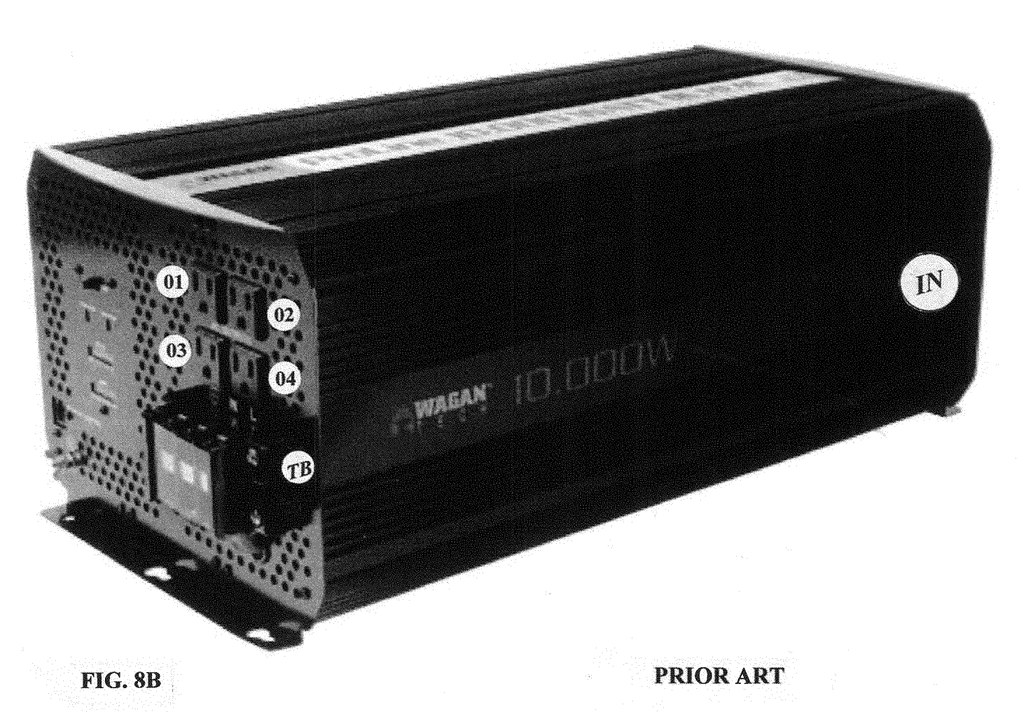

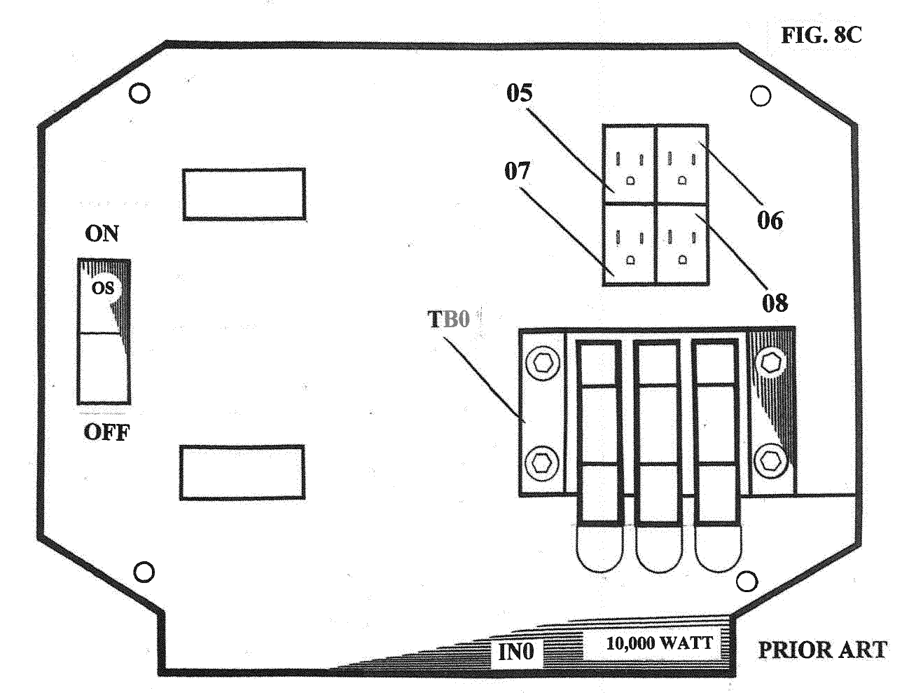

FIG. 8A is defined by battery-pack HV having plugs P1, P2 and joined to a motor MG4;

FIG. 8B is a 10,000 Watt Inverter IN which performs, as a 10,000 Watt Power Adapter;

FIG. 8C is a 10,000 Watt Inverter IN0 performing, as a 10,000 Watt Power Adapter also;

FIGS. 8A, 8B and 8C: all of which are defined by photocopies with respect to PRIOR ART.

### DETAILED DESCRIPTION OF THE PREFERRED EMBODIMENTS

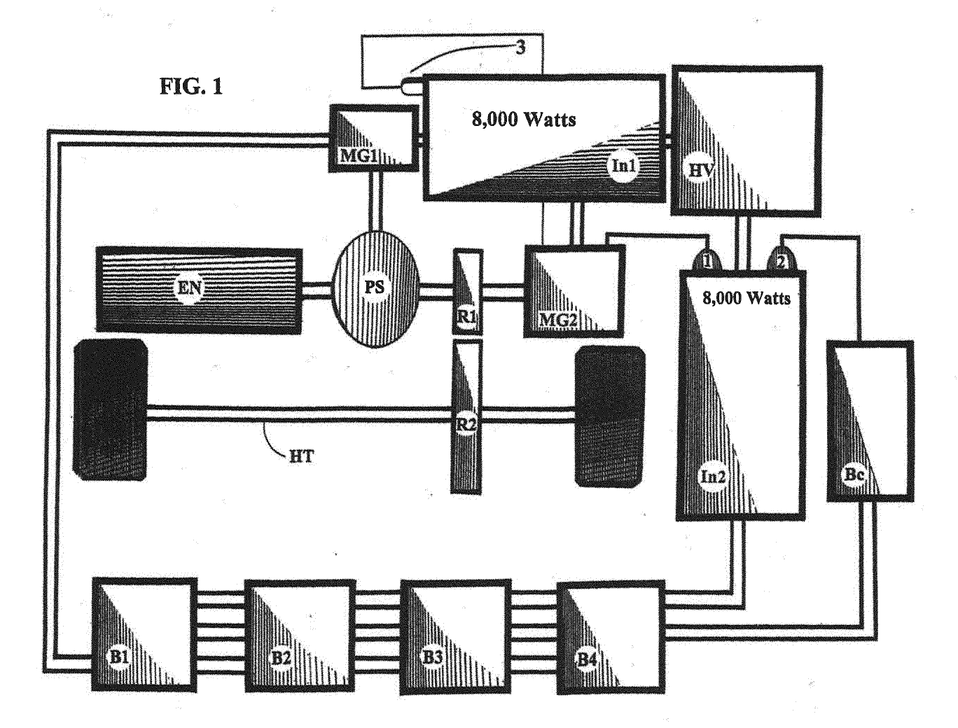

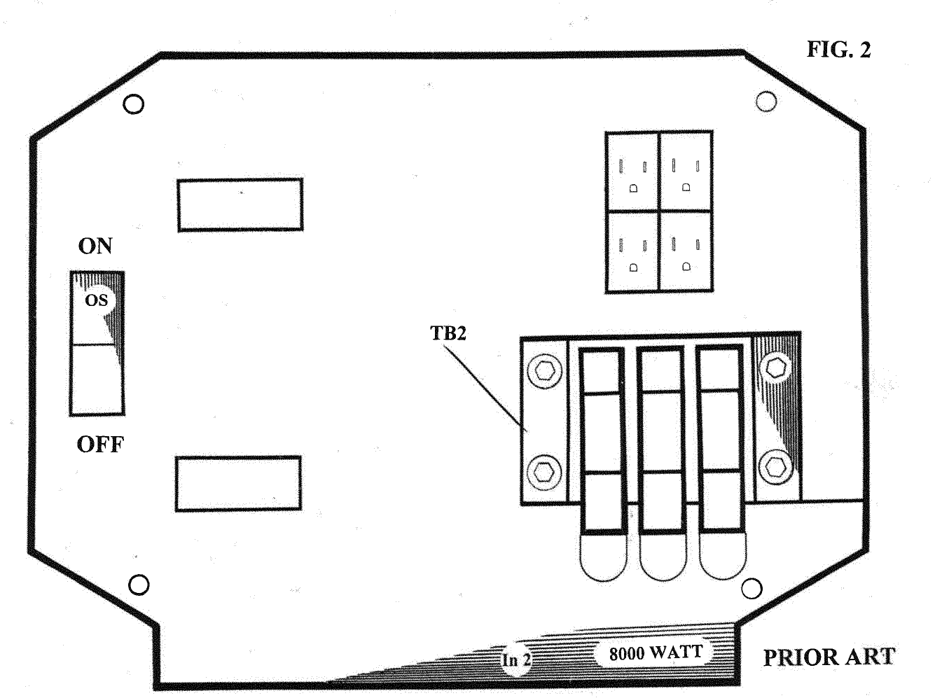

FIGS. 1, and 2 are defined by a system for applying gasoline to a hybrid vehicle fuel tank once a year having a first, and second twin inverters In1, and In2, a first, and second twin AC hardwire terminal blocks TB1, and TB2 (TB1 not shown) each of which is defined by a cool-down process. Moreover, the cool-down process is capable of preventing The First Law of Thermodynamics from being, thereby, violated, seeing that a conventional engine management computer, remotely, controls the vehicle drive system. The computer is capable of activating the terminal blocks TB1, and TB2 each of which is for: freeway speed, hills including faster acceleration, for charging the vehicle battery-pack HV. Seeing that the computer is capable of detecting, when the cool-down process is to end for the first terminal block TB1, the computer is capable of activating the first terminal block TB1 upon the detection. The first terminal block TB1 is now capable of operating in conjunction, therewith, the second terminal block TB2. The first and second twin inverters In1, and In2 each of which is capable of supplying an electric motor/generator MG2 with AC current for: the freeway speed, hills, and faster acceleration, for recharging the battery-pack HV concerning long trip technology.

With respect to the Detailed Description of a First Embodiment, the present invention will be discussed according to the preferred embodiments. Since there are drawings about the above brief description of the several views, these views will be referred to by specifying the numbers of the figures. The reference to these drawings shall be defined by different parts by use of reference letters, or numerals (preferably the latter). This specification will conclude with twenty new claims, particularly pointing out, and distinctly, claiming the subject matter, which the applicant regards as his invention.

### First Embodiment

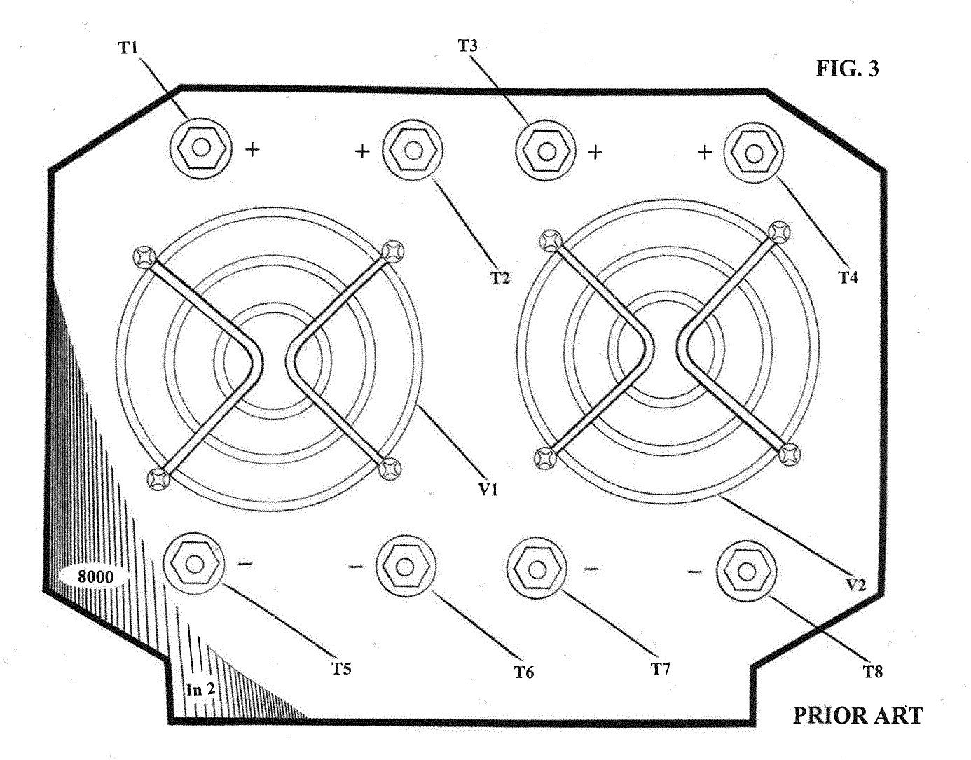

Referring to the drawings and chiefly to FIGS. 1, 2, and 3, a system for applying gasoline to a hybrid vehicle fuel tank once a year having a first, and second twin inverters In1, and In2, a first and second twin AC hardwire terminal blocks TB1, and TB2 (TB1 not shown), a cool-down process, and an engine management computerized remote control drive system comprises; A mid-size hybrid vehicle having the first, and second twin inverters In1 and In2, the first and second AC terminal blocks TB1, TB2, and eight terminals T1, T2, T3, T4, T5 T6, T7, and T8 for: joining to a first, second, third and fourth batteries B1, B2, B3, and B4.

As shown in FIG. 8, a Luxury hybrid vehicle having a third and fourth twin inverters In, and In0, a third and fourth twin AC hardwire terminal blocks TB, and TB0 (not shown), the cool-down CD process, and the engine Control-Unit (ECU) computerized remote control conventional drive system.

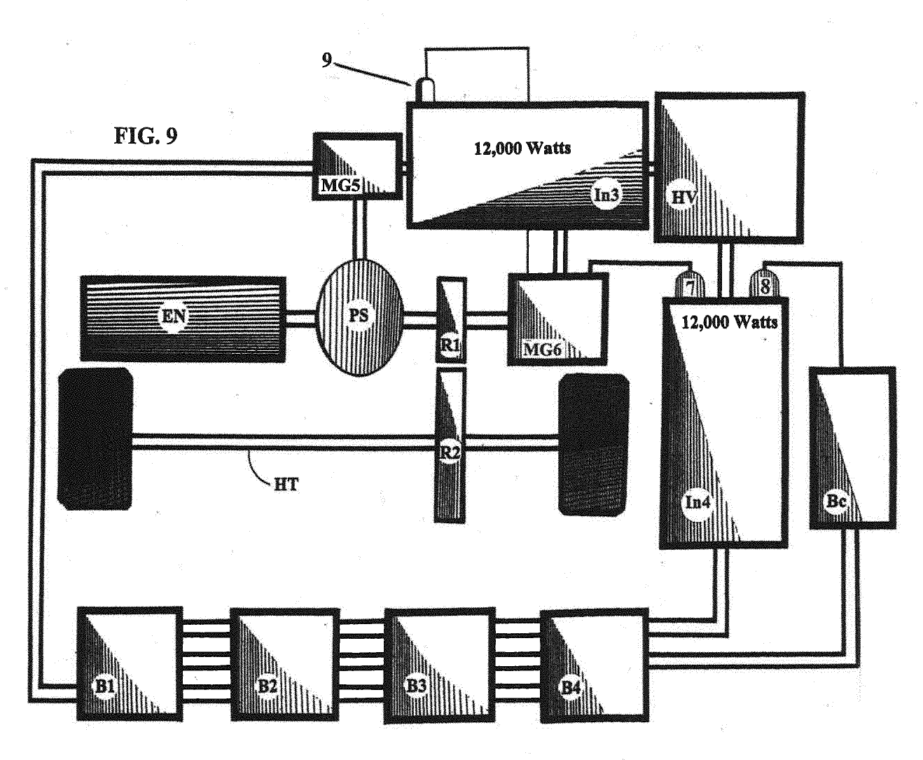

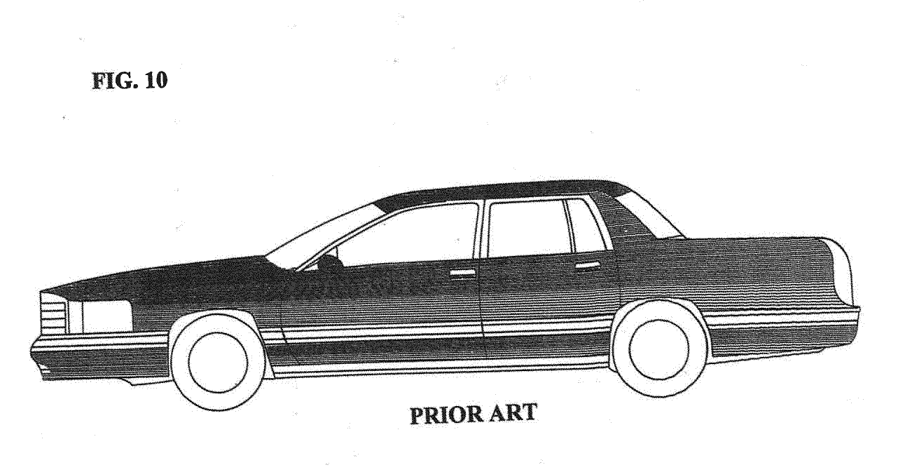

As shown in FIG. 9, a heavy-duty hybrid tactical US military vehicle having a fifth and sixth twin inverters In3, and In4, a fifth and sixth twin AC hardwire 3 phase 24 vdc three wire system terminal blocks TB3, and TB4 (not shown). The cool-down process, and the computer remote control drive system, whereby, capable of operating via US tanks, including the US Army's fleet of manned ground vehicles for: applying fuel to each gas-tank once a year.

As shown in FIG. 6, an instrument panel readout screen 68, and an ignition key-slot 69. The key-slot 69 being capable of receiving the ignition key for activating the readout screen 68. A first switch a, of a keypad KP is adjacent to the instrument panel readout screen 68. The first switch a, is defined by a finger placement surface being shaped to conform to the contours of the finger for: thereby, activating the readout screen 68, where upon the activation; the readout screen 68 recites: 1^{ST} GAS-UP: 01/01/2014, 2^{ND} GAS-UP: 01/01/2015. A second switch. OS of the second twin inverter In2 activated by the computer, a third switch OS1 (not shown) of the first inverter In1, a fourth, and fifth switch OS2, and OS3 (not shown) of the third, and fourth twin inverters In, and In0, as shown in FIG. 8 activated by the computer, and a sixth and, seventh switch OS4, and OS5 (not shown) of the fifth and sixth twin inverters In3, and In4 as shown in FIG. 9, whereby, activated via the computer when the vehicle is started.

A fifth conventional motor/generator MG5, connected to a conventional power-splitting device PS for: distributing power produced by an internal combustion engine (ICE) EN to a drive train's reduction gears R1, and R2.

As show in FIG. 9; a sixth motor/generator MG6 connected to the fifth, and sixth twin inverters In3, and In4. The fifth inverter In3, whereby joined to a conventional battery-pack HV for: converting DC supplied by the battery-pack HV to AC for activating the fifth, and sixth motor/generators MG5, and MG6, and for converting the AC supplied by the motor/generators MG5, and MG6 into DC for recharging the battery-pack HV.

The hybrid vehicle having a third charger Z6 capable of charging a ninth, tenth, eleventh, and twelfth batteries Z1, Z2, Z3, and Z4. The fourth twin AC hardwire terminal block TB0 (not shown) being fixed on the fourth twin inverter In0 shown in FIG. 8, whereby connected to the battery-pack HV for converting DC supplied by the battery-pack HV to AC for activating the fourth motor/generator MG4. The fourth motor/generator MG4 is connected to a conventional outlet of the fourth inverter In0 via a fourth plug 4.

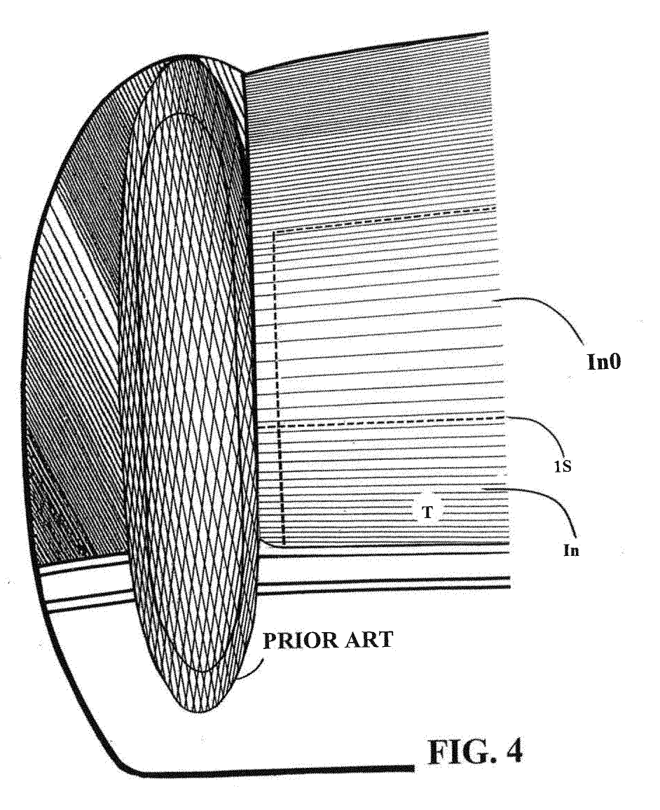

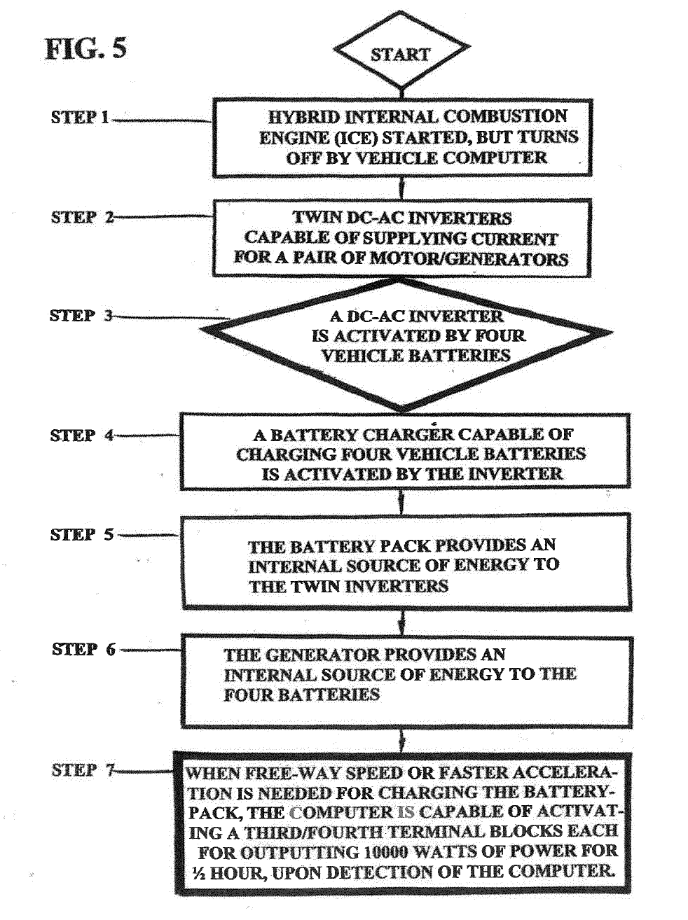

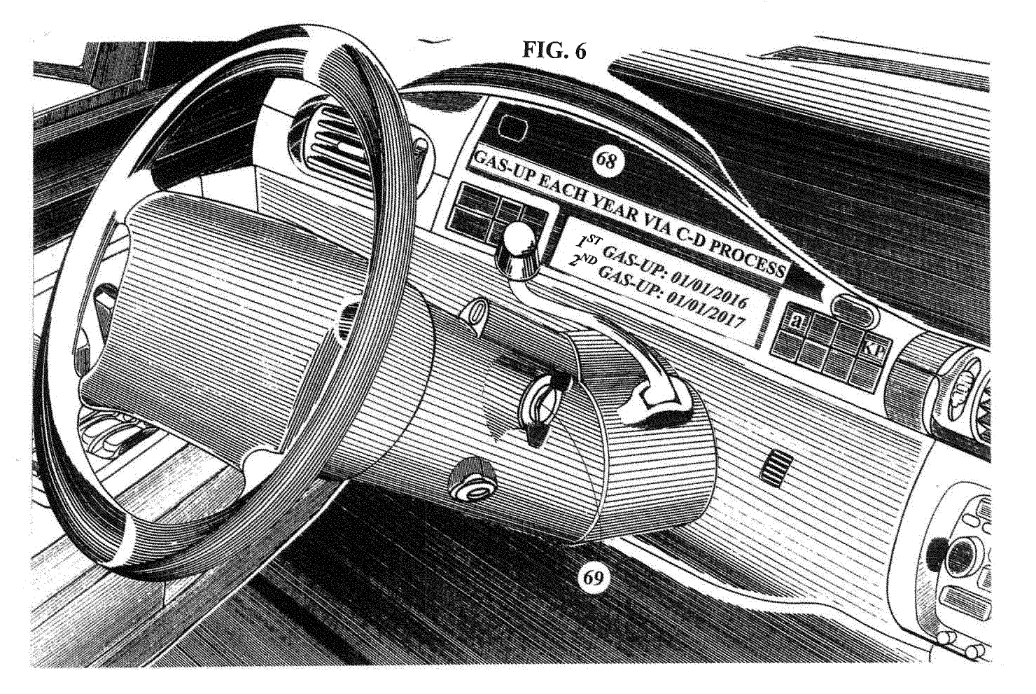

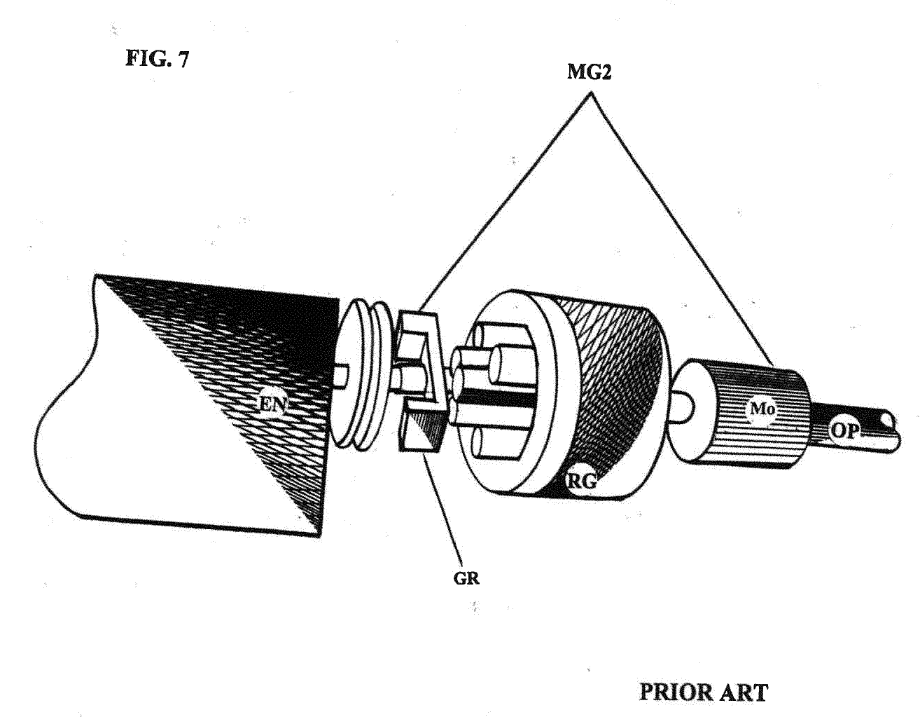

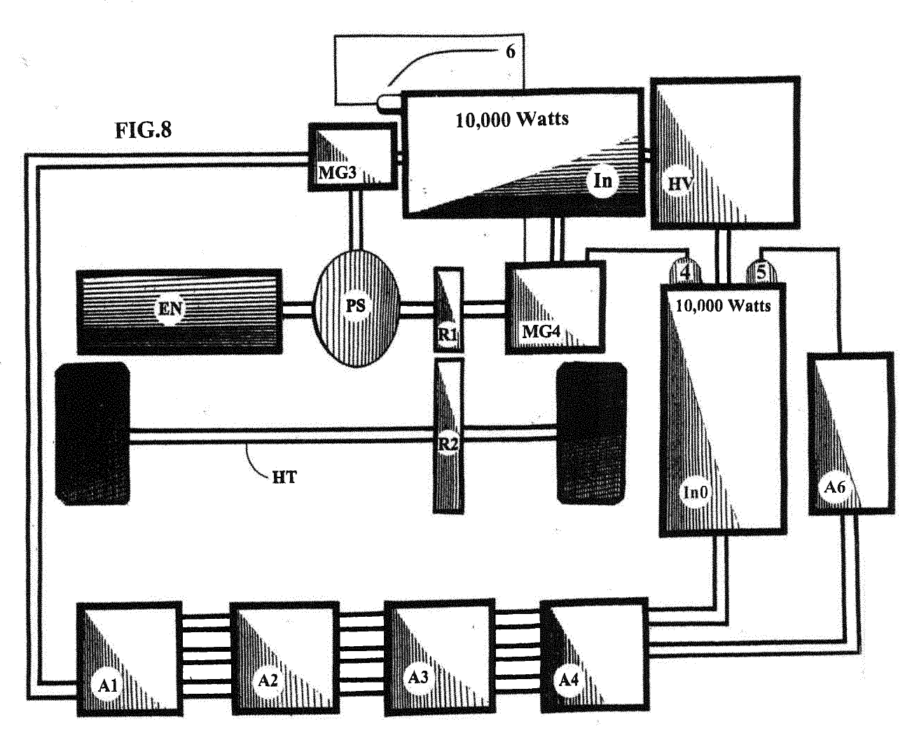

As shown in FIG. 8, a second battery charger A6 adjacent to the fourth twin inverter In0. The second charger A6, and the fourth twin inverter In0, whereby, connected to a fifth, sixth, seventh, and eight batteries A1, A2, A3, and A4, for: activating the second motor/generator MG4. The third motor/generator MG3 being connected to the fifth, sixth, seventh, and eight batteries A1, A2, A3, and A4, and when the second battery charger A6 is connected to a conventional outlet of the fourth twin inverter In0 by a fifth plug 5, the fourth motor/generator MG4 is connected to the third inverter In via a sixth plug 6. The second charger A6 being capable of charging the fifth, sixth, seventh, and eight batteries A1, A2, A3, and A4 for: supplying energy to the vehicle by its electric motor Mo via the third, and fourth inverters In and In0 by the fourth motor/generator MG4. Whereby, the gasoline engine EN is capable of starting via one ounce of the gasoline. One hundred and twenty eight ounces concerning the gasoline is equivalent to one gallon of the gasoline, and capable of yielding a hundred and twenty eight cranks per gallon. When one hundred and twenty eight cranks per gallon is multi-plied by a twenty-gallon gas tank; the gasoline is capable of yielding 2,560 startups per year.

Whereby, the third twin AC terminal block TB is defined by 10,000 Watts fixed on the third twin inverter In (not shown) for the cool-down process. The computer is capable of detecting when the cool-down process is to begin, and capable of deactivating the third terminal block TB, at the threshold to exclude The First Law of Thermodynamics from being violated. Whereby, the fourth twin AC terminal block TB0 being defined by 10,000 Watts, and fixed on the fourth twin inverter In0. The computer being capable of detecting, when the cool-down process is to begin, and capable of deactivating the fourth terminal block TB0, upon the detection, whereby, to prevent from violating the First Law of Thermodynamics.

Whereby, the computer being capable of detecting, when the change in internal energy of the system is equal to the heat added to the system minus the work performed by the system. The computer being capable of excluding the ICE EN from turning on, when The First Law of Thermodynamics is excluded from being violated via the C-D beginning stage.

Whereby, the computer being capable of activating the 10,000 Watt third or fourth twin AC terminal blocks TB/TB0, for: freeway speed, hills, and faster acceleration for charging the battery-pack HV. The cool-down process is defined by long trip technology. Whereby, the fourth 10,000 Watt AC terminal block TB0 being fixed on the fourth inverter In0, concerning the cool-down process. The computer being capable of detecting when the cool-down-process is to end and capable of activating the fourth terminal Hock TB0, Whereby, the third, and fourth twin inverters In, and In0 having a third, fourth, fifth, and sixth, fans, V3, V4, V5, and V6 (not shown), about The First Law of Thermodynamics via the application of the conservation of energy principle to heat, and Thermodynamic processes.

Whereby, the fourth motor/generator MG4 being joined to an outlet of the third inverter In, by the sixth plug 6, for: performing an activation of the motor Mo, via the fourth motor/generator MG4. The motor Mo is capable of operating via a generator GR. Whereby, the third 10,000 Watt terminal block TB is capable of operating at the end of the cool-down process. The computer is capable of deactivating the fourth 10,000 Watt terminal block TB0, and activating the third terminal block TB for the freeway, speed. Whereby, the computer being capable of deactivating the second battery charger A6, when the fifth, sixth, seventh, and eight batteries A1, A2, A3, and A4 are defined by full charge status (As shown in FIG. 8).

Whereby the second motor/generator MG2 being joined by a second 8,000 Watt inverter In2, by a first plug 1, a first charger Bc joined to the second inverter In2 by a second plug 2, and the second motor/generator MG2 joined to the first inverter In1 by a third plug 3. The third and fourth inverters In, and In0 are fixed on a surface 1S of a trunk T (shown in FIG. 4).

Moreover, the computer is capable of activating the second 8,000 Watt terminal block TB2 when the cool-down process is to end. The second terminal block TB2 is capable of operating in conjunction with the first terminal block TB1 before its cool-down process is to began. Whereby, the first motor/generator MG1 joined to the first 8,000 Watt inverter In1, having a third, and fourth fans V3, and V4 (not shown) The first and second twin inverters In1, In2, and the first charger Bc joined to a first, second, third, and fourth batteries B1, B2, B3, and B4. The first charger Bc is for Charging the first, second, third, and fourth batteries B1, B2, B3, and B4.

Whereby, the computer being capable of activating the 8,000 Watt first, or second twin AC terminal blocks TB1, TB2 for the freeway speed, and for charging the battery-pack HV; The second inverter In2 having a first, and second fans V1, and V2, via the C-D process.

As shown in FIG. 9, Whereby, the twin AC hardwire 3 phase, 24 vdc defined by 12,000 Watt fifth, and sixth terminal blocks TB3, and TB4, concerning the cool-down process. The computer being capable of detecting when the cool-down process is to begin/end for preventing The First Law of Thermodynamics from being violated, regarding the principle of conservation of energy. Whereby, the computer is capable of activating the fifth 12,000 Watt terminal block TB3 at the end of the cool-down process. The sixth terminal block TB4 is capable of operating together with the fifth terminal block TB3 until its cool-down process is to begin. A system for applying gasoline to a hybrid vehicle fuel tank once a year having a third, and fourth twin inverters, a third and fourth twin AC hardwire terminal blocks, a cool-down process, and an engine management computer remote control drive system, comprises.

A Luxury hybrid vehicle having the third, and fourth twin inverters In, In0, the third, and fourth twin AC hardwire terminal blocks TB, TB0, the cool-down process, and the engine management computerized remote control conventional drive system;

A third and fourth conventional motor/generators MG3, and MG4, thereby, connected to a conventional power splitting device PS capable of distributing power being produced by an internal combustion engine EN ICE to a drive train's reduction gears R1, and R2.

A hybrid vehicle electric motor Mo being capable of operating in conjunction with the ICE EN. The hybrid vehicle having a throttle being capable of causing current to switch direction, and being capable of moving the fourth motor/generator MG4 from motor mode to generator mode, and capable generating a regenerative braking process. The motor Mo is now called a fourth motor/generator MG4.

A Power-split or series-Parallel hybrid vehicles being generally defined by the ICE EN, and the electric motor both of which having a direct mechanical coupling to the electric drive train. The engine EN being defined by the coupling to the third, and fourth motor/generators MG3, and MG4 for gear ratios also. The drive train including a conventional transmission. being capable of shifting, whereby, to provide the necessary gear ratios for conventional hybrid operation, thereby, having an electrically variable transmission EVT to provide variable speed ratios. An output shaft of the ICE EN, and an output shaft OP of the electric motor Mo both of which are capable of being connected in parallel via a coupling device, thereby, being capable of decreasing harmful exhaust emissions, and maximizing fuel economy. The hybrid vehicles being generally defined by the regenerative braking, which is an energy recovery mechanism being capable of slowing the vehicle by converting its kinetic energy into another form, whereby, the energy is capable of being consumed immediately or stored, thereby, being capable of recharging the fifth, sixth, seventh, and eighth batteries A1, A2, A3, and A4 of the Luxury hybrid vehicle. The computer, thereby, being capable of detecting, when the fifth, sixth, seventh, and eighth batteries A1, A2, A3, and A4, are being charged by the regenerative braking energy.

The computer being predetermined and capable of detecting when the change in internal energy of the hybrid vehicle system. is equal to the amount of heat supplied to the system, minus the amount of work performed by the system. The computer is capable of turning on the ICE EN, when The First Law of Thermodynamics is at the threshold of being violated. The computer being capable of detecting, when the cool-down process is to prevent The First Law of Thermodynamics from being violated.

The computer being capable of excluding the ICE EN from turning on, when The First Law of Thermodynamics is excluded from being violated via the C-D process, and via the conservation of energy. The regenerative braking energy being capable of charging the fifth, sixth, seventh, and eighth batteries A1, A2, A3, and A4, including the hybrid vehicle battery-pack HV. The computer being capable of detecting when the cool-down process is to begin, or end with respect to The First Law of Thermodynamics concerning long trip technology.

A system for applying gasoline to a hybrid vehicle fuel tank once a year, comprises: a first and second twin AC inverter for: the hybrid vehicle. The first and second inverters having a first and second twin AC hardwire terminal blocks, a cool-down C-D process, and a conventional engine management computerized remote-control drive system, whereby, being capable of activating the twin AC terminal blocks for freeway speed, hills, faster acceleration, and a hybrid vehicle momentum regenerative braking kinetic energy process for: charging a battery-pack, and multiply batteries. The computer being capable of activating the first terminal block, when the cool-down process is to end, and deactivating the second terminal block, when the cool-down process is to begin. The computer is capable of activating the first/second terminal blocks each of which is capable of operating with respect to ½ hour for: the freeway speed.

The regenerative braking being an energy recover mechanism, whereby, being capable of slowing the vehicle by converting the kinetic energy into another form, which is capable of being used immediately, or stored in the multiple batteries, and the battery-pack. The regenerative brake must be combined via a friction brake for stopping short. The computer being capable of deactivating the first terminal block, when the first terminal block is being defined by the cool-down process, whereby, to prevent The First Law of Thermodynamics from being, thereby, violated via an amount of heat generated with respect to the application of the conservation of energy. The computer being capable of activating the second terminal block simultaneously, when the cool-down process of the second terminal block is to end. The second inverter being capable of supplying AC current concerning a conventional hybrid electric motor via a motor/generator to propel the vehicle along a surface of a road. The cool-down process with respect to earth includes: winter, spring, summer, and fall, including rain, snow, hail-storms defined by ice, and the greatest cool-down process upon the face of the earth being the Ocean. The ocean being capable of cooling-down the earth to prevent from violating The First Law of Thermodynamic processes. The earth being defined by a change in internal energy of its system, whereby, being capable of performing a manner of work via rotating, thereby, being equal to the heat added to the earth's system via a greater light to rule the day, and minus the work performed by the system, whereby, the Ocean being capable of preventing The First Law of Thermodynamics from being violated, whereby, the Ocean being defined by a conventional cool-down process with respect to the face of all the earth. I wisdom dwell with prudence, and find out knowledge of witty inventions.

Aims Power Inverters concerning the above 8,000 Watts continuous power/16,000 Watts surge capacity (peak power) which includes: AC Hardwire terminal block, Remote switch capability, Four AC receptacles, Voltmeter and Amp meter, Powerful internal high-speed cooling fans, High voltage protection, Low voltage protection, Overload protection, Low battery alarm, Low battery shutdown. Since the 8,000 Watt/16,000 Watt Power inverter converts 12 volt DC to 110 volt AC up to 8000 watts continuous power, this inverter is defined by Maximum efficiency approximately 90%. According to the first embodiment, this system will now be described in more detail by a Step by Step Flowchart shown in FIG. 5.

Step 1: a hybrid combustion engine (ICE) started, but thus turned off via a computer. We know that hybrids, and all-electric vehicles create their own power for recharging batteries, whereby through a process known as regenerative braking (regenerative mode).

Notwithstanding, we understand that in the hybrid, or ail electric vehicle the word “regenerative,” in terms of regenerative braking, means capturing the vehicle momentum (kinetic energy) and turning it into electricity, which is capable of recharging the first set of four storage batteries, or multiple batteries for the mid-size vehicles. The second set of four batteries are for the Luxury vehicles, and the third set of four batteries are for the heavy-duty hybrid tactical United States military vehicles, and capable of operating via US tanks, including the US Army's fleet of manned ground vehicles, for applying fuel to each vehicle's gas-tank once a year. When the vehicles are slowing down and/or stopping, the first set, the second set, and the third set of charged batteries, whereby, capable of providing power to the vehicles electric conventional traction motor.

Step 2, a sixth motor/generator is connected to a fifth and sixth twin inverters. The fifth inverter, whereby, joined to a conventional battery-pack for: converting DC supplied by the battery-pack to AC for activating the fifth, and sixth motor/generators, and for converting the AC supplied by the fifth and sixth motor/generators into DC for, thereby, recharging the battery-pack.

Step 3, a second battery charger adjacent to the fourth twin inverter, whereby, the second charger, and the fourth twin inverter are joined to a fifth sixth, seventh and eight batteries, for activating the fourth inverter. Step 4, when the second battery charger is connected to a conventional outlet of the fourth twin inverter by a fifth plug, the fourth motor/generator is connected to the third inverter via a sixth plug. The second charger is thus, capable of charging the fifth, sixth, seventh, and eight batteries for: supplying energy to the vehicle by its electric motor via the third, and fourth inverters, by the fourth motor/generator.

Step 5, is defined by the first, and second twin inverters, each of which is connected to the battery-pack via eight terminals for: receiving an internal source of energy with respect to the above modification.

Step 6, with respect to the all-electric vehicle, this motor is the sole source of locomotion. In the hybrid vehicles, the motor works in conjunction/in combination at the same time with the internal combustion engine ICE. Notwithstanding, the motor is not just a source of propulsion, it's also a generator. Therefore, any permanent magnet motor can operate as either a motor or generator. In all-electric, and hybrid vehicles, they are more precisely called a motor/generator (M/G). With respect to any vehicle design, there must be a mechanical connection between the M/G and the drive train. In an all-electric vehicle, there could be an individual M/G at each wheel, or a central M/G connected to the drive train through a gearbox RG. In a hybrid the motor/generator could be an individual component, which is capable of being driven by an accessory belt from the engine EN (much like an alternator on a conventional vehicle). This is how the MG system works, it could be a conventional M/G, which is bolted between the engine EN, and transmission PS (this is the most common setup), or it could be multiple M/Gs mounted inside the transmission PS (this is how the two-modes work). In any case, the M/G has to be capable of propelling the vehicle, as well as be driven by the vehicle in regenerative mode. Step 7, most, or all hybrids, and electrics use an electronic throttle control system. When the throttle pedal is pushed, a signal is thereby, sent to the onboard computer, which further activates a relay in the controller (not shown) that will send battery current through twin inverters In1, and In2 to the motor/generator MG2, which is capable of causing the hybrid vehicle to move. The harder the pedal is pushed, the mote current flows under direction of a variable resistance controller, and the faster the vehicle is sent on a short course of travel in a brief space of time. In a hybrid, depending upon load, battery state-of-charge and the design of the hybrid drive train, a heavy throttle will also activate the internal combustion engine EN ICE for more power. Whereby, lifting slightly off the throttle will decrease current flow to the motor, and the vehicle will slow down. Lifting further or, thereby, completely off the throttle will cause the current to switch direction, whereby, moving the motor/generator MG2 from motor mode to generator mode, and begin the regenerative braking process.

When the electronic throttle is closed, and the vehicle still moving, all of its kinetic energy can be captured to both slow the vehicle, and recharge its first set of four batteries

As the onboard computer signals the batteries to stop sending electricity (via the controller relay), and start receiving it (through a charge controller), the motor/generator MG2 simultaneously stops receiving electricity for powering the vehicle, and starts sending current back to the batteries for charging. When the motor/generator MG2 is supplied with electricity, it makes mechanical power, and when it's supplied with mechanical power, it makes electricity. But, how does generating electricity slow the vehicle? Friction, seeing that it's the adversary of motion; the armature of the motor/generator MG2 is slowed by the force of inducing current in the windings, as it passes over the opposing poles in the magnets in the stator (it's constantly battling the push/pull of the opposing polarities). E.g., the magnetic friction slowly weakens the vehicle kinetic energy, and helps to decrease speed. The physical application of the generator to the vehicle wheels slows the vehicle down. Although effective on their own, a regenerative brake must be combined with a conventional friction brake to ensure proper deceleration for different driving situations, via stopping short with respect to the above modification.

Output Wave Form Modified Sine wave, input voltage range 10-15 VDC, Output voltage range 115 VAC 60 HZ, Low voltage alarm 10.5 VDC, Low voltag voltage shutdown 10.0 VDC, Thermal shutdown yes, AC receptacles 4, Warranty 1 year, inverter weight 42.6 lbs, Shipping weight 44 lbs, Product dimensions 22.5″L×11″W×8.25″H. Aims 10,000 Watts continuous power/20,000 Watts surge capacity (peak Power) Inverter includes: AC hardwire terminal block, Remote switch capability, four AC receptacles, Voltmeter and Amp meter, Powerful internal high-speed cooling fans, High voltage protection, Low voltage protection, Overload protection, Low battery alarm, Low battery shutdown, including Maximum efficiency approximately 90% No-load draw Switch On <2.5 ADC, Output Wave Form Modified Sine wave, Input voltage range 10-15 VDC, Output voltage 115 +/−5.0 VAC 60 HZ,
Low voltage alarm 1.0.5+/−0.5 VDC, Low voltage shutdown 10.0+/−0.5 VDC, Thermal shutdown Yes, AC receptacles 4, Warranty 1 year, Inverter weight 44 lbs, Shipping weight 46 lbs, and Product dimensions 22.5″L×11″W×8.5″H, whereby converts 12 volt DC to 115 volt AC up to 10,000 watts continuous power. Aims 12,000 Watt, 3 Phase, 24 vdc inverter, Model # PWR12KW24V3P208 Pure Sine Wave Advantage Features: Over-load protection, Short-circuit protection, Output wave form: Pure Sine Wave, Three thermal, individually controlled cooling fans, 3 phase, 6 outlets, DC battery post design for high current draw, handles for easy transport, mounting plates, LED indicator, 1 direct connect terminal block, Display 1: Measures voltage at each DC input, Display 2: Measures the AC output current for each phase, Display 3: Measures the AC output voltage with respect to ground, Display 4: Measures the AC output voltage from leg to leg. Specifications: Continuous wattage: 12,000 3 phase three wire system, Input Voltage: DC24V+20%, Output Voltage: 3 phase AC208V/120V 60 HZ, Output voltage tolerance: 2%, Power toleration: 2%, THD: <3% (With line load), Frequency: 60 Hz+0.1 Hz, Efficiency: >82%, Power factor: COS c −0.8, Ambient temperature: —10 +35, Ambient moisture: <90% no dew, Overload capacity: 3 minutes 15,000 watts, 10 seconds for 18,000 watts, Noise (1 meter distance) <60 dB, Input over-voltage protection: DC 28.8V, Input low-voltage protection: DC 1.9.2V, Input reverse-connection protection, Output over-voltage protection: AC 219V, Output low-voltage

An internal combustion engine (ICE) is capable of being started via one ounce of gasoline, whereby, one hundred and twenty eight ounces of the gasoline being equivalent to one U. S. gallon of the gasoline, and capable of yielding a hundred and twenty eight start-ups per gallon. Moreover, when the one hundred and twenty eight start-ups per gallon being multiplied via a twenty gallon fuel tank, the gasoline is capable of yielding two thousand five hundred, and sixty startups per year based on the lifestyle of the vehicle user.

Due to the complexity of the activity specified in light of the above teachings, it will become apparent to persons skilled in the Art, such that the present invention is defined by a third, and fourth twin AC hard wire 10,000 Watt terminal blocks each of which being capable of outputting 10,000 Watts of continuous power for: ½ hour of operating time. The present Invention includes four 12 Volt vehicle batteries connected in parallel to double the current amp/hours, whereby, counting the auxiliary battery, yields five batteries. The five batteries each of which is defined by 100 Amp hours, the 10,000 Watt terminal blocks having remote switch capability, and is capable of operating via the computer with respect to modification. Notwithstanding, to calculate the above AC hard wire terminal block's ½ hour of output time, the above total of Amp hours can be rounded off, and calculated via 500 Amp Hours, since the battery-pack is defined by 244.8 volts. Moreover, the five batteries, consequently, can be recited via 500 Amp Hours, whereby, the Calculation is being provided as follows: the 500 Amp Hours being multiplied by 10 via Watts, thus, equal 5,000 Watt Hours. Moreover, when the 5,000 0.0 Watt Hours being divided by 10,000 Watts, Draw/Full, this equals 0.5 or ½ Hour of out-put operating time. This 10,000 Watt out-put with respect to each hard wire terminal block is for: supplying the hybrid motor with AC current for: Free-way speed, hills and faster acceleration for charging the battery-pack, since power is restored doing a power outage via terminal blocks.

The computer is being predetermined, and capable of detecting when the change in internal energy of the hybrid vehicle system is equal to the amount of heat supplied to the system, and minus the amount of work performed by the system. Moreover, The First Law of Thermodynamics is at the threshold of being violated by the third terminal block after ½ hour of output operation. The computer is capable of, thereby deactivating the third terminal block to prevent from, thus, violating The First Law of Thermodynamics upon the detection, since ½ hour of output generates an amount heat with respect to the above modification.

The computer is capable of activating the fourth twin terminal block simultaneously, when its cool-down process is to end, such that the fourth terminal block is now, capable of out-putting its 10,000 Watts of power for: ½ hour, Since the third terminal block is defined by a cool-down (C-D) process, the cool down process is to end at twenty minutes. The more batteries connected in Parallel, the more out-put operation time provided. E.g., a tractor truck is for hauling a trailer, yet a passenger bus both of Which are capable of hauling multiple batteries with respect to multiple inverters housing terminal blocks for: Freeway speed.

Due to the complexity of the activity specified in light of the above teachings, it will become apparent to persons skilled in the Art, such that the cool-down process is defined by twenty minutes, whereby, the computer is capable of activating the third terminal block, since its C-D process has come to an end. Seeing that the fourth terminal block includes only, ten minutes of out-put operation time left, whereby, the third terminal block is capable of operating in conjunction with the fourth terminal block via its ten minutes. The terminal blocks both of which being capable of out-putting 20,000 Watts of continuous power together, and a LED is capable of emitting light adjacent to 160 mph, via the vehicle's read out screen. Moreover, the user may generate a top speed of 160 mph excluding gasoline for the above ten minutes, and after the ten minutes the computer is capable of deactivating the fourth terminal block so that its C-D process is to begin.

On the other hand, the third terminal block is now, capable of out-putting its 10,000 Watts of power for generating a top speed of 100 mph excluding gasoline for ½ hour, but if the speed exceeds the 100 mph, the computer is capable of turning on the ICE with respect to modification. When the vehicle is started by the user, the vehicle's instrument panel readout screen recites: GAS-UP EACH YEAR VIA C-D PROCESS. Protection: AC 187V, Over-heat protection: 80, Size: 25.75 W×23 L×8.5 H, Weight: 110 lbs Unit, 150 in shipping crate, 1 year free technical support, and 1 year replacement warranty.

While the above description contains many specifics of which should not be construed, as limitations on the scope of the invention, many variations and modifications will thus be apparent to persons skilled in the Art to which it is related. E.g., twin AC hard wire 12,000 Watt 3 phase 24 vdc three wire multiple terminal block inverters, however, are capable of operating via a cool-down process for military Hybrid vehicles, and being capable of gassing-up once a year. This cool-down process is controlled by a vehicle engine management computer drive system for: Hybrid Tractor Trailers, Hybrid Busses, Hybrid Locomotives, Hybrid Jet Air-crafts, Spacecrafts, and all types of Air crafts. This system is capable of operating with respect to Boats, luxurious Yachts, and large ocean going Ships being capable of gassing-up once a year via multiple hard-wire terminal blocks, the computer, and cool-down process with respect to the above modification. Since the cool-down process is defined by twenty minutes, the computer is capable of activating a third 10,000 Watt terminal block, since its cool-down process has come to an end, whereby, a fourth 10,000 Watt terminal block includes only, ten minutes of output operation time left. Now, the third terminal block is capable of operating in conjunction with the fourth terminal block via its ten minutes. The terminal blocks both of which being capable of out-putting 20,000 Watts of power, whereby, a LED is capable of emitting light adjacent to 160 mph shown on an instrument panel readout screen. Now the user may generate a top speed of 160 mph, whereby, excluding gasoline for above ten minutes, and after the ten minutes the computer is capable of deactivating the fourth terminal block, such that its cool-down (CD) process is to began. On the other hand, the third terminal block is now, capable of out-putting its 10,000 Watts of continuous power for: generating a top speed of 100 mph excluding gasoline for hour of operation time, but if the speed exceeds the 100 mph, the computer is capable of turning on the ICE.

I claim:

1. A system for applying gasoline to a hybrid vehicle fuel tank once a year having a first, and second twin inverters, a first and second twin AC hardwire terminal blocks, a cool-down process, and an engine management computerized remote control drive system, comprising:
a mid-size hybrid vehicle having said first, and second twin inverters (In1, In2), said first and second AC terminal blocks (TB1, TB2), and eight terminals (T1, T2, T3,T4,T5, T6, T7, T8) for: joining to a first, second, third, and fourth batteries (B1, B2, B3, B4);
a Luxury hybrid vehicle having a third and fourth twin inverters (In, In0), a third and fourth twin AC hardwire terminal blocks (TB, TB0), said cool-down (C-D) process, and said engine management computerized remote control conventional drive system;
a heavy-duty hybrid tactical. US military vehicle having a fifth and sixth twin inverters (In3, In4), a fifth and sixth twin AC hardwire 3 phase 24 vdc three wire system terminal blocks (TB3, TB4), said cool-down process, and said computer remote control drive system, whereby, capable of operating via US tanks, including said US Army's fleet of manned ground vehicles for: applying fuel to each gas-tank once a year;
an instrument panel readout screen (68), and an ignition key slot (69); said key-slot (69) being capable of receiving said ignition key for activating said readout screen (68);
a first switch (a) of a keypad (KP) adjacent to said instrument panel readout screen (68); said first switch (a) is defined by a finger placement surface being shaped to conform to the contours of said finger for: thereby, activating said readout screen (68), where upon said activation, said readout screen (68) recites: 1^{ST} GAS-UP: 01/01/2015, 2^{ND} GAS-UP: 01/01/2016;
a second switch (OS) of said second twin inverter (In2) activated by said computer, a third switch (OS1) of said first inverter (In1), a fourth and fifth switch (OS2, OS3) of said third, and fourth twin inverters (In, In0), activated by said computer, and a sixth and seventh switch (OS4, OS5) of said fifth, and sixth twin inverters (In3, In4) being activated via said computer, when an operator being capable of turning on said vehicle;
a fifth conventional motor/generator M/G (MGS) connected to a conventional power splitting device (PS) for: distributing power produced by an internal combustion engine ICE (EN) to a drive train's reduction gears (R1, R2);
a sixth motor/generator (MG6) connected to said fifth, and sixth twin inverters (In3), (In4); said fifth inverter (In3), whereby, joined to a conventional battery-pack (HV) for: converting DC supplied by said battery-pack (HV) to AC for activating said fifth, and sixth motor/generators (MG5, MG6), and for converting said AC supplied by said fifth and sixth motor/generators (MG5, MG6) into DC for recharging said battery-pack HV; said vehicle having a third charger (Z6) capable of charging a ninth, tenth, eleventh, and twelfth batteries (Z1, Z2, Z3, Z4);
said fourth twin AC hardwire terminal block T-B (TB0) being fixed on said fourth twin inverter (In0), whereby, connected to said battery-pack (HV) for converting DC supplied by said battery-pack (HV) to AC for activating said fourth motor/generator (MG4); said fourth motor/generator (MG4) is connected to a conventional Outlet of said fourth inverter (In0) via a fourth plug (4);
a second charger (A6) adjacent to said fourth twin inverter (In0); said second charger (A6), and said fourth twin inverter (In0), whereby, connected to a fifth, sixth, seventh, and eight batteries (A1, A2, A3, A4), for: activating said fourth motor/generator (MG4); said third motor/generator (MG3) being connected to said fifth, sixth, seventh, and eight batteries (A1, A2, 43, A4); and when said second charger (A6) is connected to a conventional outlet of said fourth twin inverter (In0) by a fifth plug (5), said fourth motor/generator (MG4) connected to said third inverter (In) via a sixth plug (6); said
second charger (A6) being capable of charging said fifth, sixth, seventh, and eight batteries (A1, A2, A3, A4) for: supplying energy to said vehicle by its electric motor (Mo) via said third, and fourth inverters (In, In0) by said fourth M/G (MG4).

2. A system for applying gasoline to a hybrid vehicle fuel tank once a year as defined in claim 1, wherein said gasoline engine (EN) being capable of starting via one ounce of said gasoline, one hundred and twenty eight ounces of said gasoline being equivalent (equal) to one gallon of said gasoline, and capable of yielding a hundred and twenty eight startups per gallon.

3. A system for applying gasoline to a hybrid vehicle fuel tank once a year as defined in claim 1, wherein said one hundred and twenty eight startups per gallon are multiplied by a twenty-gallon fuel tank; said gasoline being capable of yielding 2,560 startups per year via a lifestyle of a user.

4. A system for applying gasoline to a hybrid vehicle fuel tank once a year as defined in claim 1, wherein said third twin AC terminal block (TB) is defined by 10,000 Watts, fixed on said third twin inverter (In) for said cool-down process; said computer is capable of detecting when said cool-down process is to began, and capable of deactivating said third terminal block (TB), at the threshold to exclude The First Law of Thermodynamics from being violated.

5. A system for applying gasoline to a hybrid vehicle fuel tank once a year as defined in claim 1, wherein said fourth AC terminal block (TB0) being capable of out-putting 10,000 Watts for: ½ hour, and being fixed on said fourth inverter (In0); said computer being capable of detecting when said cool-down process is to began, and capable of deactivating said fourth terminal block (TB0) upon said detection, whereby, to prevent from violating The first law of Thermodynamics.

6. A system for applying gasoline to a hybrid vehicle fuel tank once a year as defined in claim 1, wherein said computer being capable of detecting, when the change in internal energy of said system is equal to the heat added to said system minus the work performed by said system; said computer being capable of excluding said engine (EN) from turning on, when The First Law of Thermodynamics is excluded from being violated via said cool-down process beginning stage.

7. A system for applying gasoline to a hybrid vehicle fuel tank once a year as defined in claim 1, wherein said computer being capable of activating said 10,000 Watt third or fourth twin AC terminal blocks (TB, TB0), for: ½ hour concerning freeway speed, hills, and faster acceleration for charging said battery-pack (HV); said cool-down process is defined by long trip technology.

8. A system for applying gasoline to a hybrid vehicle fuel tank once a year as defined in claim 1, wherein said fourth 10,000 Watt AC terminal block (TB0) being fixed on said fourth inverter (In0), about said CD-process; said computer being capable of detecting when said C-D process is to end, and capable of activating said fourth terminal block (In0) for ½ hour of operation time.

9. A system for applying gasoline to a hybrid vehicle fuel tank once a year as defined in claim 1, wherein said 10,000 Watt third and fourth twin inverters (In, In0) having a third, fourth, fifth, and sixth fans, (V3, V4, V5, V6) about The First Law of Thermodynamics via the application of the conservation of energy principle to heat, and Thermodynamic processes;

10. A system for applying gasoline to a hybrid vehicle fuel tank once a year as defined in claim 1, wherein said fourth motor/generator (MG4) being joined to an outlet of said third inverter (In), by said sixth plug (6), for: performing an activation of said motor (Mo), via said fourth motor/generator (MG4); said motor (Mo) is capable of operating via a generator (GR).

11. A system for applying gasoline to a hybrid vehicle fuel tank once a year as defined in claim 1, wherein said third 10,000 Watt terminal block (TB) is capable of operating at the end of said cool-down process; said computer is capable of deactivating said fourth 10,000 Watt terminal block (TB0), and activating said third terminal block (TB) for said freeway speed.

12. A system for applying gasoline to a hybrid vehicle fuel tank once a year as defined in claim 1, wherein said computer being capable of deactivating said second charger (A6), When said fifth, sixth, seventh and eight batteries (A1, A2, A3, A4) are defined by full charge status.

13. A system for applying gasoline to a hybrid vehicle fuel tank once a year as defined in claim 1, wherein said second motor/generator (MG2) being joined by a second 8,000 Watt inverter (In2), by a first plug (1), a first charger (Bc) joined to said second inverter (In2) by a second plug (2), and said second motor/generator (MG2) joined to said first inverter (In1) by a third plug (3); said third and fourth inverters (In, In0) fixed on a surface (1S) of a trunk (T).

14. A system for applying gasoline to a hybrid vehicle fuel tank once a year as defined in claim 1, wherein said computer is capable of activating said second 8,000 Watt terminal block (T-B) (TB2), when said cool-down process is to end; said second T-B (TB2) is capable of operating in conjunction with said first terminal block (TB1) before its cool-down process is to began.

15. A system for applying gasoline to a hybrid vehicle fuel tank once a year as defined in claim 1, wherein said first motor/generator (MG1) joined to said first 8,000 Watt inverter (In1), having a third and fourth fans (V3, V4); said first and second twin inverters (In1, In2), and said first charger (Bc) joined to a first, second, third and fourth batteries (B1, B2, B3, B4); said first charger Bc is capable of charging said first, second, third and fourth batteries (B1, B2, B3, B4).

16. A system for applying gasoline to a hybrid vehicle fuel tank once a year as defined in claim 1, wherein said computer being capable of activating said 8,000 Watt first, car second twin AC terminal blocks (TB1, TB2) for said freeway speed, for charging said battery-pack (HV); said second inverter (In2) having a first and second fans (V1, V2), via said C-D process.

17. A system for applying gasoline to a hybrid vehicle fuel tank once a year as defined in claim 1, wherein said twin AC hardwire 3 phase, 24 vdc defined by 12,000 Watt fifth, and sixth terminal blocks (TB3, TB4), concerning said cool-down process; said computer being capable of detecting, when said cool-down process is to began/end for, thereby, preventing The First Law of Thermodynamics from being violated with respect to the principle of the conservation of energy.

18. A system for applying gasoline to a hybrid vehicle fuel tank once a year as defined in claim 1, wherein said computer is capable of activating said fifth 12,000 W terminal block (TB3) at said end of said cool-down process; said sixth terminal block (TB4) is capable of operating in conjunction together with said fifth terminal block (TB3) until its cool-down process is to began.

19. A system for applying gasoline to a hybrid vehicle fuel tank once a year having a third, and fourth twin inverters, a third and fourth twin AC hardwire terminal blocks (TB), a cool-down-process, and an engine Control Unit (ECU) computer remote control drive system, comprising;
a Luxury hybrid vehicle having said third and fourth twin inverters (In, In0), said third and fourth twin AC hardwire terminal blocks (TB, TB0), said cool-down process, and said engine Control Unit computerized remote control conventional drive system;
a third and fourth conventional motor/generators (MG3, MG4), thereby, connected to a conventional power splitting device (PS) capable of distributing power being produced by an internal combustion engine (EN) ICE to a drive train's reduction gears (R1, R2);
a hybrid vehicle electric motor (Mo) being capable of operating in conjunction with said ICE (EN); said hybrid vehicle having a throttle being capable of causing current to switch direction, and being capable of moving said fourth motor/generator (MG4) from motor mode (Mo) to generator mode (GR), and capable of generating a regenerative braking process; said motor (Mo) is now called a fourth motor/generator (MG4);
a Power-split or series-Parallel hybrid vehicles being generally defined by said ICE (EN), and said electric motor (Mo) both of which having a direct mechanical coupling to said electric drive train; said engine (EN) being defined by said coupling to said third and fourth motor/generators (MG3), (MG4) for gear ratios also;
said drive train including a conventional transmission being capable of shifting, Whereby to provide said necessary gear ratios for conventional hybrid operation, thereby, having an electrically variable transmission EVT to provide variable speed ratios;
an output shaft of said ICE (EN), and an output shaft (OP) of said electric motor (Mo) both of which are capable of being connected in parallel via a coupling device, thereby being capable of decreasing harmful exhaust emissions, and maximizing fuel economy;
said hybrid vehicles being generally defined by said regenerative braking, which is an energy recovery mechanism being capable of slowing said vehicle by converting its kinetic energy into another form, whereby, said energy is capable of being consumed immediately or stored, thereby, being capable of recharging said fifth, sixth, seventh, and eighth batteries (A1, A2, A3, A4) of said Luxury hybrid vehicle; said computer, thereby, being capable of detecting, when said fifth, sixth, seventh, and eighth batteries (A1, A2, A3, A4), are being charged by said regenerative braking energy;
said computer being predetermined, and capable of detecting when the change in internal energy of said hybrid vehicle system is equal to the amount of heat supplied to said system, minus the amount of work preformed by said system; said computer is capable of turning on said ICE (EN) of a heretofore hybrid, but turning on said third or fourth inverter when The First Law of Thermodynamics is at the threshold of being violated;
said computer being capable of detecting when said cool-down process is to prevent The First Law of Thermodynamics from being violated; said computer being capable of excluding said ICE (EN) from turning on, when The First Law of Thermodynamics is excluded from being violated via the C-D process, and via the conservation of energy;
said regenerative braking energy being capable of charging said fifth, sixth, seventh, and eighth batteries (A1, A2, A3, A4), including said hybrid vehicle battery-pack HV; said computer being capable of detecting when said cool-down process is to began or end with respect to The First Law of Thermodynamics concerning long trip technology.

20. A system for applying gasoline to a hybrid vehicle fuel tank once a year, comprising:
a first, and second twin AC inverters for: said hybrid vehicle; said first and second inverters having a first and second twin AC hardwire terminal blocks, a cool-down (C-D) process, and a conventional engine Control Unit ECU computerized remote-control drive system, whereby, being capable of activating said twin AC terminal blocks for freeway speed, hills, faster acceleration, and a hybrid vehicle momentum regenerative braking kinetic energy process for: charging a battery-pack and multiple batteries;
said computer being capable of activating said first terminal block, when said cool-down process is to end, and deactivating said second terminal block, when said cool-down process is to began; said computer is capable of activating said first, or second terminal blocks, whereby, for operating in conjunction with one another for said freeway speed;
said regenerative braking being an energy recover mechanism, thereby, being capable of slowing said vehicle by converting said kinetic energy into another form, which is capable of being used immediately, or stored in said multiple batteries, and said battery-pack; said regenerative brake must be combined via a friction brake for stopping short;
said computer being capable of deactivating said first terminal block, when said first terminal block is being defined by said cool-down process, whereby, to prevent The First Law of Thermodynamics from being, thereby, violated via an amount of heat generated with respect to the application of the conservation of energy via multiple terminal blocks;
said computer being capable of activating said second terminal block simultaneously, when said cool-down process of said second terminal block is to end; said second inverter being capable of supplying AC current concerning a conventional hybrid electric motor via a motor/generator to propel said vehicle along a surface of a road;
said cool-down process with respect to earth comprises: winter, spring, summer, and all, including rain, snow, hail-storms defined by ice, and the greatest cool-down process upon the face of said earth being the ocean; said ocean being capable of cooling-down said earth to prevent from violating The First Law of Thermodynamic processes;
said earth being defined by a change in internal energy of its system, whereby, being capable of performing a manner of work via rotating, thereby, being equal to the heat added to said earth's system via a greater light to ride the day, and minus the work performed by said system, whereby, said ocean being capable of preventing The First Law of Thermodynamics from being violated, whereby, said ocean being defined by a conventional cool-down process with respect to the face of all the earth; I wisdom dwell with prudence, and find out knowledge of witty inventions.
